(19) United States
(12) Patent Application Publication
(10) Pub. No.: US 2015/0064310 A1
(43) Pub. Date: Mar. 5, 2015

(54) Endurance sports drink utilizing tapioca starch

(71) Applicant: Darren Thompson, Fallbrook, CA (US)

(72) Inventor: Darren Thompson, Fallbrook, CA (US)

(21) Appl. No.: 14/476,727

(22) Filed: Sep. 3, 2014

Related U.S. Application Data
(60) Provisional application No. 61/873,645, filed on Sep. 4, 2013.

(51) Int. Cl. A23L 2/52; A23L 2/38

(52) U.S. Cl. CPC A23L 2/52; A23L 2/38; A23V 2002/00
USPC 426/63; 426/590; 426/74; 426/72

(57) ABSTRACT

A sports drink mixture for making a sports drink that remains palatable while providing nutritional and energy benefits without causing negative physiological responses in the human body includes compositions of: tapioca starch, further including compositions of unprocessed and pregelatinized tapioca starch; bromelain; natural flavors; citric acid; vitamin E oil; stevia; potassium phosphate; sodium citrate; magnesium chloride; ascorbic acid; niacinamide; d-calcium pantothenate; pyridoxine hydrochloride; riboflavin; thiamine hydrochloride; folic acid; biotin; and cyanocobalamin. A sports drink includes compositions of the sports drink mixture with an aqueous liquid.

### CROSS-REFERENCE TO RELATED APPLICATIONS

This application claims the benefit of U.S. Provisional Application No. 61/873,645, filed Sep. 4, 2013.

### FIELD OF THE INVENTION

The present invention relates generally to the field of nutritional supplements for athletes, and more particularly to tapioca-based sports drinks for endurance athletes.

### BACKGROUND OF THE INVENTION

Athletic nutritional supplements are often sought by athletes in order to aid in preparation for a workout as well as aid in post-workout recovery. Nutritional supplements are also consumed during a workout in order to replenish water, electrolytes, and food energy that have been lost. This is particularly prevalent among endurance athletes such as marathon runners, distance cyclists, and triathletes as training or competing in an event can result in hundreds of calories burning per hour of activity.

In order to maintain peak performance throughout an endurance event, it is required to consume food during a race. Nutritional supplements are available in a variety of forms including energy bars, energy gels, and sports drinks (powdered and otherwise).

However, due to logistical reasons relating to ease and convenience of consumption, most athletes prefer to consume nutritional supplements in liquid form. Several factors must be taken into consideration when choosing the types of nutritional supplements to consume in an athletic situation. It is important that any ingested nutritional supplements do not exacerbate the feelings of nausea that may be experienced due to a high level of physical exertion during activity.

Consuming sports drinks can result in bloating and nausea that can negatively affect an athlete's performance. This is particularly the case for sugary sports drinks with high levels of dextrose, sucrose, and fructose, among other sugars. Sports drinks that are based on mid-length carbohydrates, such as maltodextrin, are also subject to exerting a high osmotic pressure in the stomach, which can result in bloating, nausea, and vomiting, as well as further dehydrating the athlete by pulling water out of the blood into the stomach. Sugary sports drinks and sports drinks that are based on mid-length carbohydrates are not designed for a steady, sustained release of energy.

Poor palatability is another issue that must be taken into consideration, as many nutritional supplements that provide prolonged, steady release of energy are unpalatable, despite their nutritional benefits.

Several types of sports drinks are based on long chain carbohydrates such as starch. While these sports drinks exert a low osmotic pressure in the stomach, are rapidly cleared from the stomach, and will provide a slow, sustained release of sugar into the bloodstream, many types of starch, including corn and potato starch, do not dissolve well in cold water, resulting in poor palatability with an unpleasant aftertaste and texture sensation.

As such, considering the foregoing, it may be appreciated that there continues to be a need for novel and improved compositions for sports drinks that remain palatable while providing nutritional and energy benefits, without provoking negative physiological responses in the body.

### SUMMARY OF THE INVENTION

The foregoing needs are met, to a great extent, by the present invention, wherein in aspects of this invention, enhancements are provided to the existing model of starch-based drink compositions.

Various aspects of the present invention seek to provide a sports drink, which creates a low glycemic load and does not cause a sudden spike in blood sugar during athletic activity. Related aspects seeks to address the aforementioned issues relating to athletic nutritional supplements as well as provide users with a solution that is both effective and palatable.

Related aspects of the present invention provide a tapioca-based sports drink for endurance athletes. The sports drink is designed to remain palatable while providing nutritional and energy benefits without provoking negative physiological responses in the body.

In an aspect, the tapioca is utilized as a primary energy source in order to overcome issues of poor palatability and undesirable physiological responses inherent in current existing products.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of composition and to the arrangements of the components set forth in the following description. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

N/A

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the specification describes in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

In an embodiment of the present invention, a sports drink or sports drink mixture can comprise tapioca, one or more flavoring agents, a coloring agent, one or more sweeteners, a prophylactic anti-inflammatory agent to reduce exercise related inflammation and discomfort, rehydration salts to replace those lost through perspiration, and one or more stabilizers.

Tapioca, also referred to as tapioca starch, is a starch extracted from the Cassava plant.

In a related embodiment, tapioca can be used as a primary source of energy and can be slowly digested in the small intestine resulting in simple sugars being slowly and steadily released into an athlete's bloodstream. In the context of a sports drink, tapioca has better properties for use in drinks and drink mixtures than other starches, such as corn starch, potato starch, rice starch, and wheat starch. This is due to tapioca's ability to dissolve much more thoroughly in cold water. Furthermore, the fact that tapioca has a neutral taste when dissolved in water results in an improved feeling in the mouth during consumption.

In addition, the molecular packing structure of the amylopectin portion of the tapioca starch molecules is much denser than those of corn starch, potato starch, rice starch, or wheat starch. This is due to the fact that tapioca has an A type packing structure whereas corn, potato, rice, and wheat have a B type packing structure. The dense packing structure of tapioca starch results in more energy per unit delivered to the athlete during consumption of the sports drink. Furthermore, tapioca, like other starches, exerts a low osmotic pressure on the stomach, preventing bloating and nausea.

In a related embodiment, the sports drink can be available in powder form, as a sports drink mixture, and may be mixed with water. The composition can also be available in other forms of delivery common to sports endurance fuels including, but not limited to, single dose gels, pre-diluted drinks, and energy bars. While the sports drink is primarily intended for use by endurance athletes, the present invention is not limited solely to endurance athletes, and may be utilized as a nutritional supplement by all athletes, or other people that are engaging in strenuous work or exercises.

In various related embodiments, the sports drink and compositions of the present invention comprises tapioca as a base ingredient. Within the scope of the present invention, the terms ‘tapioca’ and ‘cassava’ are considered synonymous and may be utilized interchangeably.

Additionally, the tapioca starch may be unmodified (native), modified (including pregelatinized, chemically/otherwise modified), or a combination thereof.

Tapioca is rich in carbohydrates and is thus utilized as a primary source of energy during athletic activity. Tapioca is also low in saturated fat, cholesterol, and sodium as well. The use of tapioca as a primary ingredient yields several benefits in the context of athletic activity, particularly in endurance athletes.

Tapioca readily and thoroughly dissolves in cold water. A commonly encountered issue with corn starch and potato starch based formulas is the tendency for the starch molecules to have poor dissolvability in water. When combined with water, the resulting mixture maintains a paste-like consistency that is unpleasant and unpalatable during consumption, and may be associated with a “chalky” aftertaste. In contrast, because tapioca dissolves well in cold water, the resulting sports drink is palatable and pleasant in the mouth.

In addition, tapioca inherently lacks taste, improving palatability when consumed in conjunction with flavorings. Additionally, tapioca exerts a low osmotic pressure on the stomach. As such, when the sports drink is consumed, the liquid is rapidly released from the stomach and into the small intestine for digestion. This greatly reduces bloating and feelings of nausea during and after consumption of the sports drink.

Furthermore, tapioca has a low glycemic index and is digested slowly in the small intestine. As a result, sugar is released slowly and steadily into the bloodstream after consumption. This is ideal for endurance athletes as the slow release of energy does not cause an insulin response and allows for prolonged, sustainable release of energy during the course of a long workout or competition. Consequently, athlete hunger and food cravings are reduced.

Without an intake of energy during prolonged exercise, non-diabetic hypoglycemia, or low blood sugar, is common amongst athletes, resulting in symptoms such as shakiness, loss of mental acuity, headache, weakness, blurred vision, and tachycardia.

Conversely, fueling with simple carbohydrates such as maltodextrin or sugars such as sucrose, fructose, glucose, and dextrose can result in gastrointestinal stress and dehydration due to the high osmotic pressure of the smaller molecules in the stomach. This can also lead to dramatic and detrimental swings in blood sugar levels as sugar rapidly enters the blood, inducing an insulin response that drives down sugar levels, resulting in a sugar crash. A sugar crash results in blood sugar levels dipping below the level prior to consumption of the fuel, exacerbating the non-diabetic hypoglycemia previously discussed.

Finally, tapioca starch molecules (amylopectin) have a denser packing structure relative to corn starch, rice starch, and wheat starch molecules. The dense packing structure of the tapioca starch molecules results in a higher energy density. The increased sugar density results in the delivery of a higher level of energy per unit as an athlete consumes the sports drink.

In the various related embodiments, advantages of the sports drink mixture with tapioca over conventional sports drink mixtures include:
a. slow sustained release of sugar into the blood, as a function of the size and complexity of the starch molecule, particularly the amylopectin molecule;
b. low glycemic index;
c. low osmotic pressure, such that it does not draw water out of the blood into the stomach, such as a sugar based drink would;
d. rapid clearing from the stomach into the small intestine, in contrast to products based on maltodextrin that must be digested in the stomach; and
e. high palatability, providing an “easy to drink” sensation, in contrast to corn or potato starch based products.

In further related embodiments, the sports drink mixture can comprise one or more flavoring agents. The flavoring agents serve to further increase the palatability of the sports drink. The present invention is not limited with respect to the specific flavoring agents available for use in the sports drink. For example, the sports drink may incorporate a variety of flavors such as vanilla, chocolate, and fruit flavors.

Flavoring of the sports drink can be uniform in composition or blended with multiple types of flavoring agents.

In other further related embodiments, the sport drink mixture can comprise a coloring agent. The coloring agent improves the aesthetic appearance of the sports drink when mixed with cold water. The present invention is not limited with respect to the specific coloring agent. However, the coloring agent is preferably natural, free of preservatives, and free of taste.

In other further related embodiments, in order to increase palatability of the sports drink further, the sports drink can comprise one or more sweeteners. As with the coloring agent, sweeteners used in the sports drink are preferably natural and free of taste. Additionally, the sweeteners can be selected such that they do not have an impact on blood sugar levels. Sugar alcohol and stevia are two examples of sweeteners that have a negligible impact on blood glucose. However, the sweeteners of related embodiments of the present invention are not limited to these two examples.

In other further related embodiments, the sports drink mixture can further comprise a prophylactic anti-inflammatory agent. This can reduce the risk of systemic inflammation and associated discomfort from prolonged and strenuous exercise. The elevated intensity levels of exercise may weaken the immune system as well, increasing the likeliness of illness following a strenuous event. Bromelain, in the form of a composition of the enzymes stem bromelain (EC 3.4.22.32) and fruit bromelain (EC 3.4.22.33) can be included as an anti-inflammatory agent. Another common prophylactic anti-inflamatory agents used by athletes is ibuprofen, which has some potentially harmful side effects, including nausea as well as impeding bone and muscle growth. Other natural examples of prophylactic anti-inflamatory agents include omega-3 fatty acids, curcumin, ginger, cinnamon, and garlic. None of these natural alternatives are as efficacious as Bromelain, though.

In other further related embodiments, the sports drink mixture can include rehydration salts, also known as electrolyte salts. Perspiration during exercise can result in the loss of electrolyte salts such as sodium, potassium, calcium, and magnesium, thereby causing an athlete to become dehydrated and electrolyte-deficient. The present invention is not limited with respect to the specific composition of the rehydration salts. However, rehydration salts are typically composed of a mixture of salts of sodium, potassium, calcium, and magnesium. Such a mixture of rehydration salts can for example be a composition of potassium phosphate, sodium citrate, and magnesium chloride.

In other further related embodiments, the sports drink mixture can include one or more stabilizers. Stabilizers can be utilized to ensure the homogeneous dispersion of two or more substances, particularly when the substances do not normally mix. In the context of related embodiments of the present invention, stabilizers maintain the consistency of the sports drink and prevent the separation of the ingredients. Additionally, the stabilizers can improve the shelf life of the dry powdered product.

In various embodiments, concentration of the ingredients of the sports drink mixture can vary, for example in order to improve the taste and quality of the sports drink as well as its stability and shelf life.

In related embodiments, the sports drink can be mixed with cold water. An appropriate serving of powdered ingredients of the sports drink is placed into a beverage container and mixed with a corresponding portion of cold water. The beverage container is shaken until the powdered ingredients are thoroughly dissolved in the water. The sports drink may then be consumed normally.

After consumption, the tapioca portion of the sports drink is rapidly released from the stomach and into the small intestine. As the sports drink is digested, energy is released slowly and steadily into the bloodstream. This is particularly beneficial for endurance athletes as the slow and steady release of energy is prolonged throughout the course of a long workout or event. Additionally, the rapid release into the small intestine, can help reduce any feelings of bloating and/or nausea that can result from having excess liquids in the stomach during intense exercise.

In an embodiment, one serving of the sports drink can be consumed 30 minutes prior to initiating exercise, with one additional serving consumed for each 60 minutes of continued exercise. In alternative embodiments of the present invention, the sports drink can be consumed in the recovery period, following intense or prolonged exercise, in order to replenish energy.

In various embodiments, the specific composition and ingredient ratios can vary. For example, a post-exercise recovery configuration of an embodiment of the present invention can incorporate protein, branched chain amino acids, and lipids, as well as other ingredients in addition to the previously discussed ingredients.

In further alternative embodiments of the present invention, the sports drink can be utilized as an appetite suppressant, in order to reduce overall calorie intake. Due to tapioca starch's slow release of sugar into the bloodstream, the sports drink is ideal for promoting a feeling of satiety and reducing hunger and food cravings. As such, the present invention can be utilized in weight control applications due to the use of tapioca starch as an appetite suppressant. Additionally, due to the slow release of sugar into the bloodstream, such embodiments of the present invention may be used in products for diabetics.

In an embodiment, a sports drink mixture can comprise the following ingredients:
a) tapioca starch, in a total percentages by weight range of 75%-99;
b) bromelain, in a total percentages by weight range of 0.25%-7%;
c) natural flavors, in a total percentages by weight range of 0.5%-12.5%;
d) citric acid, in a total percentages by weight range of 0.5%-12.5%;
e) vitamin E oil, in a total percentages by weight range of 0.5%-12.5%;
f) stevia, in a total percentages by weight range of 0.5%-12.5%;
g) potassium phosphate, in a total percentages by weight range of 0.12%-3.1%;
h) sodium citrate, in a total percentages by weight range of 0.08%-2.1%;
i) magnesium chloride, in a total percentages by weight range of 0.1%-2.5%;
j) ascorbic acid, in a total percentages by weight range of 0.01%-0.2%;
k) niacinamide, in a total percentages by weight range of 0.003%-0.07%;
l) d-calcium pantothenate, in a total percentages by weight range of 0.0015%-0.04%;
m) pyridoxine hydrochloride, in a total percentages by weight range of 0.003%-0.008%;
n) riboflavin, in a total percentages by weight range of 0.0002%-0.006%;
o) thiamine hydrochloride, in a total percentages by weight range of 0.0002%-0.005%;
p) folic acid, in a total percentages by weight range of 0.00005%-0.0015%;
q) biotin, in a total percentages by weight range of 0.00004%-0.0011%;
r) cyanocobalamin, in a total percentages by weight range of 0.000001%-0.00002%;
   wherein the ingredients add up to a total percentage by weight of 100%, whereby the sports drink is mixed with an aqueous liquid to produce a sports drink.

In a related embodiment, the aqueous liquid can be water.

In a related embodiment, the vitamin E oil can be a natural vitamin E oil, derived from natural sources.

In a related embodiment, the bromelain can have a strength of 600 GDU/G (gelatin digesting units per gram).

In a related embodiment, the tapioca starch can be a composition of unprocessed tapioca starch and pregelatinized tapioca starch. Unprocessed tapioca starch can also be referred to as native tapioca starch. Conventional tapioca based products, such as for example tapioca pearls used in boba tea, all use cooked tapioca, which does not have the many beneficial properties of the compositions of tapioca disclosed herein.

Unprocessed tapioca starch is a raw form of tapioca that has not been subjected to any form of heat treatment, or any other form of gelatinization or pregelatinization treatment. Unprocessed tapioca starch may have been subjected to water rinsing, dehydration, and other extraction techniques in order to isolate the pure starch from the other components including proteins, lipids, and cellular detritus present in the raw unprocessed cassava tuber and cassava plant

In a further related embodiment, the tapioca starch composition can include a ratio of 17 parts of native tapioca starch to 3 parts of pregelatinized tapioca starch.

In a related embodiment, the natural flavors, can be a composition of natural flavors, wherein a natural flavor, can include the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional.

In a related embodiment, a method of manufacturing of the sport drink mixture can include blending of all ingredients in a bulk powder blender, mixing 200 kg or more at a time, such that all of the ingredients are added and mixed, and then packaged into tubs and labeled.

In a related embodiment, the tapioca starch can be derived from organically grown cassava.

In a related embodiment, potassium phosphate and sodium citrate can be included in a relative weight ratio of 1.615 parts potassium phosphate to 1 parts sodium citrate. This ratio of potassium to sodium is reversed, as compared to almost all energy and sports drink products on the market. In related embodiments, potassium phosphate and sodium citrate can be included in a relative weight ratio in a range from 1.4 to 1.8.

In a related embodiment, a serving of a sports drink can include:
a. a 37 g serving of the sports drink mixture; and
b. 470 ml of water.

In a related example embodiment, 37.000 g of the sports drink mixture can comprise:
a) tapioca starch, with a weight of 32,618.8923 mg;
b) bromelain, with a weight of 450.0000 mg;
c) a composition of natural flavors, citric acid, vitamin E oil, and stevia, with a combined weight of 3,368.7414 mg;
d) potassium phosphate, with a weight of 227.2658 mg;
e) sodium citrate, with a weight of 140.7000 mg;
f) magnesium chloride, with a weight of 170.2000 mg;
g) ascorbic acid, with a weight of 15.0000 mg;
h) niacinamide, with a weight of 5.0000 mg;
i) d-calcium pantothenate, with a weight of 2.7240 mg;
j) pyridoxine hydrochloride, with a weight of 0.5000 mg;
k) riboflavin, with a weight of 0.4250 mg;
l) thiamine hydrochloride, with a weight of 0.3750 mg;
m) folic acid, with a weight of 0.1000 mg;
n) biotin, with a weight of 0.0750 mg; and
o) cyanocobalamin, with a weight of 0.0015 mg.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A beverage mixture for making a sports beverage that remains palatable, while providing nutritional and energy benefits, without causing adverse physiological responses, comprising:
a. tapioca starch;
b. bromelain; and
c. at least one rehydration salt;
whereby a user mixes a predetermined serving weight of the beverage mixture with a predetermined serving volume of an aqueous liquid to produce the sports beverage.

2. The beverage mixture of claim 1, wherein
a. the tapioca starch is in a total percentages by weight range of 75%-99;
b. the bromelain is in a total percentages by weight range of 0.25%-7%;
c. the at least one rehydration salt further comprises:
i. potassium phosphate in a total percentages by weight range of 0.12%-3.1%;
ii. sodium citrate in a total percentages by weight range of 0.08%-2.1%; and
iii. magnesium chloride in a total percentages by weight range of 0.1%-2.5%.

3. The beverage mixture of claim 1, further comprising:
a. at least one natural flavor, in a total percentages by weight range of 0.5%-12.5%;
b. citric acid, in a total percentages by weight range of 0.5%-12.5%;
c. vitamin E oil, in a total percentages by weight range of 0.5%-12.5%; and
d. stevia, in a total percentages by weight range of 0.5%-12.5%.

4. The beverage mixture of claim 1, further comprising:
a. ascorbic acid, in a total percentages by weight range of 0.01%-0.2%;
b. niacinamide, in a total percentages by weight range of 0.003%-0.07%;
c. d-calcium pantothenate, in a total percentages by weight range of 0.0015%-0.04%;
d. pyridoxine hydrochloride, in a total percentages by weight range of 0.003%-0.008%;
e. riboflavin, in a total percentages by weight range of 0.0002%-0.006%; and
f. thiamine hydrochloride, in a total percentages by weight range of 0.0002%-0.005%.

5. The beverage mixture of claim 1, further comprising:
a. folic acid, in a total percentages by weight range of 0.00005%-0.0015%;
b. biotin, in a total percentages by weight range of 0.00004%-0.0011%; and
c. cyanocobalamin, in a total percentages by weight range of 0.000001%-0.00002%.

6. The beverage mixture of claim 1, wherein the bromelain has a strength of 600 gelatin digesting units per gram.

7. The beverage mixture of claim 1, wherein the tapioca starch is a composition of unprocessed tapioca starch and pregelatinized tapioca starch.

8. The beverage mixture of claim 7, wherein the tapioca starch is a composition of 17 parts unprocessed tapioca starch to 3 parts pregelatinized tapioca starch by weight.

9. The beverage mixture of claim 1, further comprising maltodextrin.

10. The beverage mixture of claim 2, wherein the potassium phosphate and the sodium citrate is included in a relative weight ratio of potassium phosphate to sodium citrate in a range of 1.4:1.0 to 1.8:1.0

11. A sports beverage that remains palatable while providing nutritional and energy benefits, without causing adverse physiological responses, comprising:
i. a beverage mixture, further comprising:
a. tapioca starch, further comprising a composition of unprocessed tapioca starch and pregelatinized tapioca starch; and
ii. an aqueous liquid.

12. The beverage mixture of claim 11, wherein the tapioca starch is a composition of 17 parts unprocessed tapioca starch to 3 parts pregelatinized tapioca starch by weight.

13. The sports beverage of claim 11, wherein
iii. the tapioca starch is in a total percentages by weight of the beverage mixture range of 75%-99; and
iv. the beverage mixture further comprises:
b. bromelain, in a total percentages by weight of the beverage mixture range of 0.25%-7%;
c. potassium phosphate, in a total percentages by weight of the beverage mixture range of 0.12%-3.1%;
d. sodium citrate, in a total percentages by weight of the beverage mixture range of 0.08%-2.1%; and
e. magnesium chloride, in a total percentages by weight of the beverage mixture range of 0.1%-2.5%.

14. The sports beverage of claim 11, wherein the aqueous liquid is water.

15. The sports beverage of claim 11, wherein the beverage mixture further comprises:
a. at least one natural flavor, in a total percentages by weight of the beverage mixture range of 0.5%-12.5%;
b. citric acid, in a total percentages by weight of the beverage mixture range of 0.5%-12.5%;
c. vitamin E oil, in a total percentages by weight of the beverage mixture range of 0.5%-12.5%; and
d. stevia, in a total percentages by weight of the beverage mixture range of 0.5%-12.5%.

16. The sports beverage of claim 11, wherein the beverage mixture further comprises:
a. ascorbic acid, in a total percentages by weight of the beverage mixture range of 0.01%-0.2%;
b. niacinamide, in a total percentages by weight of the beverage mixture range of 0.003%-0.07%;
c. d-calcium pantothenate, in a total percentages by weight of the beverage mixture range of 0.0015%-0.04%;
d. pyridoxine hydrochloride, in a total percentages by weight of the beverage mixture range of 0.003%-0.008%;
e. riboflavin, in a total percentages by weight range of 0.0002%-0.006%; and
f. thiamine hydrochloride, in a total percentages by weight of the beverage mixture range of 0.0002%-0.005%.

17. The sports beverage of claim 11, wherein the beverage mixture further comprises:
a. folic acid, in a total percentages by weight of the beverage mixture range of 0.00005%-0.0015%;
b. biotin, in a total percentages by weight of the beverage mixture range of 0.00004%-0.0011%; and
c. cyanocobalamin, in a total percentages by weight of the beverage mixture range of 0.000001%-0.00002%;

18. The sports beverage claim 13, wherein the bromelain has a strength of 600 gelatin digesting units per gram.

19. The sports beverage claim 13, wherein the potassium phosphate and the sodium citrate is included in a relative weight ratio of potassium phosphate to sodium citrate in a range of 1.4:1 to 1.8:1.

20. The sports beverage of claim 11, wherein the beverage mixture and the aqueous solution is comprised of a ratio of 37 g of the beverage mixture to 470 ml of the aqueous solution.
